(19) United States
(12) Patent Application Publication
(10) Pub. No.: US 2007/0091340 A1
(43) Pub. Date: Apr. 26, 2007

(54) Method and program for image processing

(75) Inventor: Kazuyuki Miyaki, Nagoya-shi (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/580,107

(22) Filed: Oct. 13, 2006

(30) Foreign Application Priority Data
Oct. 13, 2005 (JP) P2005-298328

(51) Int. Cl. H04N 1/60

(52) U.S. Cl. 358/1.9; 358/1.13

(57) ABSTRACT

If a profile ID data is attached to image data inputted from an application program, this means that profile conversion has been performed on the image data in the application program. Thus, the image data is directly sent to a printer without the profile conversion being performed on the image data in a printer driver. However, if a profile ID data is not attached to the inputted image data, this means that the profile conversion has not been performed on the image data in the application program. Thus, the profile conversion is performed on the image data in the printer driver as needed before the image data is sent to a printer.

### CROSS REFERENCE TO RELATED APPLICATION

This application claims priority from Japanese Patent Application No. 2005-298328 filed Oct. 13, 2005. The entire content of this priority application is incorporated herein by reference.

### TECHNICAL FIELD

The disclosure relates to a method of image processing and a program implementing the image processing method, and particularly to an image processing method and program for processing images without losing image quality.

### BACKGROUND

Normally, images taken by a digital camera or the like are printed on a printing device by launching an application program on a computer and using the application program to perform image processing and to issue a print command to the printing device.

At this time, a driver program installed on the computer to drive the printing device converts the image data received from the application program to image data suitable for the printing device and outputs the converted image data to the printing device.

One such image-processing device disclosed in Japanese Unexamined Patent-Application Publication No. 2000-125144 writes data by the application program as a profile of the image data, and performs color matching based on the profile (profile conversion) by the printer driver based on the profile.

However, in some cases, after an application program has performed color conversion on an image based on a profile, the printer driver performs color conversion on the image based on the profile again when printing the image. When color conversion is performed a plurality of times in this way (twice in this example), the quality of the image may suffer.

### SUMMARY

In view of the foregoing, it is an object of the invention to overcome the above problems and also to provide an image-processing program and image-processing method for processing images according to a profile without losing image quality due to performing the processing a plurality of times.

In order to attain the above and other objects, the invention provides a storage medium storing an image-processing program for converting an image data into an image data that is suited to a prescribed printing device. The image-processing program includes: a) selectively performing a profile conversion on an image data in an application program; b) determining whether the profile conversion has been performed on the image data in the application program; and c) performing the profile conversion on the image data in a printer driver only when it was determined in the step b) that the profile conversion has not been performed on the image data.

There is also provided an image-processing method for converting an image data into an image data that is suited to a prescribed printing device. The image-processing method includes a) selectively performing a profile conversion on an image data in an application program; b) determining whether the profile conversion has been performed on the image data in the application program; and c) performing the profile conversion on the image data in a printer driver only when it was determined in the step b) that the profile conversion has not been performed on the image data.

### BRIEF DESCRIPTION OF THE DRAWINGS

Illustrative aspects in accordance with the invention will be described in detail with reference to the following figures wherein:

FIG. 1 is a block diagram showing the electrical structure of a computer according to illustrative aspects of the invention;

FIG. 2 is an explanatory diagram showing a profile specification window in which a profile is specified in a process performed by an application program;

FIG. 3 is an explanatory diagram showing a Property window in which printer properties are set during a process performed by a printer driver;

FIG. 4 is a flowchart representing a process performed by the application program; and

FIG. 5 is a flowchart representing a process performed by the printer driver.

### DETAILED DESCRIPTION

Some aspects of the invention will be described while referring to the accompanying drawings wherein like parts and components are designated by the same reference numerals to avoid duplicating description.

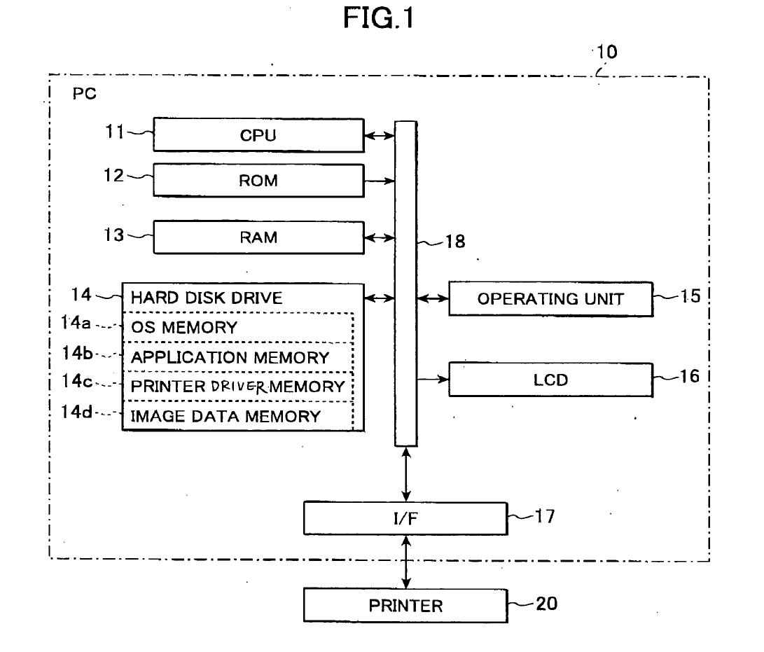

FIG. 1 is a block diagram showing the electrical structure of a personal computer 10 and a printer 20 connected to the personal computer 10. The personal computer 10 serves as an image-processing device on which the image-processing program of the invention is executed.

The personal computer 10 includes a central processing unit (CPU) 11, a read-only-memory (ROM) 12, a random-access-memory (RAM) 13, a hard disk drive (HDD) 14, an operating unit 15, a liquid crystal display (LCD) 16, and a printer interface (I/F) 17, all of which components are connected to one another other via a bus 18.

The CPU 11 is a processing device for executing computer programs stored in the ROM 12, the RAM 13, and the HDD 14. The ROM 12 is a memory for storing basic programs, such as a paper-feeding program.

The hard disk drive 14 is a rewritable memory including an OS memory 14a for storing an operating system that runs on the personal computer 10, an application memory 14b for storing an application program, a printer driver memory 14c for storing a printer driver, and an image data memory 14d for storing image data.

The RAM 13 is a rewritable memory for temporarily storing data and the like required for processes executed by the CPU 11. When executing programs, such as the application program or the printer driver stored on the HDD 14, these programs are transferred to the RAM 13 and executed.

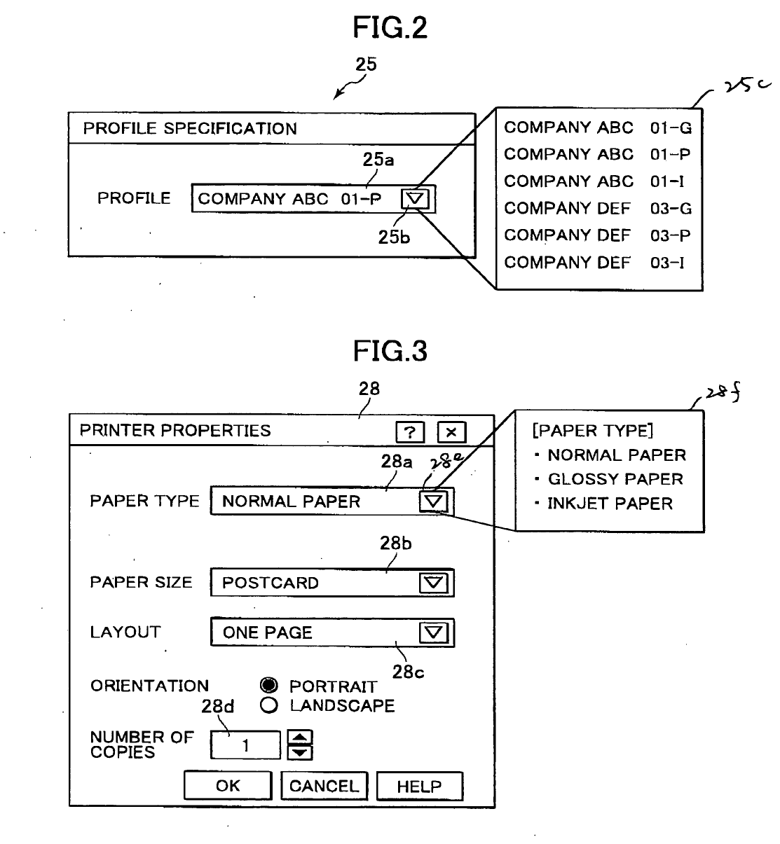

A process for specifying a profile performed in the application program will be described with reference to FIG. 2. FIG. 2 shows a profile specification window 25 displayed on the LCD 16 when a user elects to specify a profile while running the application program. When the user specifies a profile in the profile specification window 25, image data is converted based on the specified profile, and profile ID data identifying the specified profile is attached to the converted image data, and the image data together with the profile ID data is outputted from the application program to the printer driver. If a profile is not specified, the image data is outputted to the printer driver without being converted based on a profile.

As shown in FIG. 2, the profile specification window 25 includes a display window 25a, and a pull-down icon 25b having an inverted triangular shape. By moving a cursor (not shown) and clicking on the pull-down icon 25b with a mouse (not shown), the user can display a pull-down menu 25c displaying a plurality of profile names. In this state, the user can specify a desired profile by again moving the cursor and clicking on a corresponding one of the profile names.

Each profile name in this example is configured of a printer-manufacturer name, such as “Company ABC”; a number indicating the printer model, such as “01”; and a letter signifying the type of recording paper, such as “G” and “P”. Note that a profile is provided for each printer model and for each type of paper used in the printer. In some cases, a common profile can be used for a plurality of printer models.

Next, various items set during a process (described later) performed with the printer driver will be described with reference to FIG. 3. FIG. 3 shows a Properties window 28 displayed on the LCD 16 when the printer driver is executed for enabling the user to set various printer properties.

The Properties window 28 includes a paper type selection box 28a for selecting the type of paper or other recording medium on which printing will be performed, a paper size setting box 28b for setting the paper size, a layout setting box 28c for setting the layout on the printing surface, and a quantity setting box 28d for setting the number of copies to be printed.

The paper type selection box 28a includes a display area for displaying the selected paper type, and an icon 28e having a downward pointing triangular shape disposed on the right end of the display area. The user can display a pull-down menu 28f by aligning the cursor with the icon 28e and clicking with the mouse. Next, the user moves the cursor over a desired item displayed in the pull-down menu 28f and selects the item with a mouse click.

For example, the user can select among such paper types as normal paper, glossy paper, and inkjet paper. After the user selects one of these paper types, the personal computer 10 selects a profile best suited for the selected paper type.

Similarly, the paper size setting box 28b includes an area for displaying the selected paper size, and an icon for displaying a pull-down menu of possible selections. For example, the user can select from among such paper sizes as postcard, B5, A4, B4, and A3.

The layout setting box 28c enables the user to select whether one page worth of data is to be recorded on one sheet of paper, or whether two pages are to be printed on one sheet of paper.

The quantity setting box 28d includes a display area for display the number of copies to be printed; and to the right of the displaying area, an increment icon having a downward pointing triangular shape for increasing the number and a decrement icon having a downward pointing triangular shape for decreasing the number. Hence, the user can set a desired number of documents to be printed by aligning the cursor over these icons and operating the mouse. It is also possible to input a desired number of documents to be printed directly through a ten-key pad or the like.

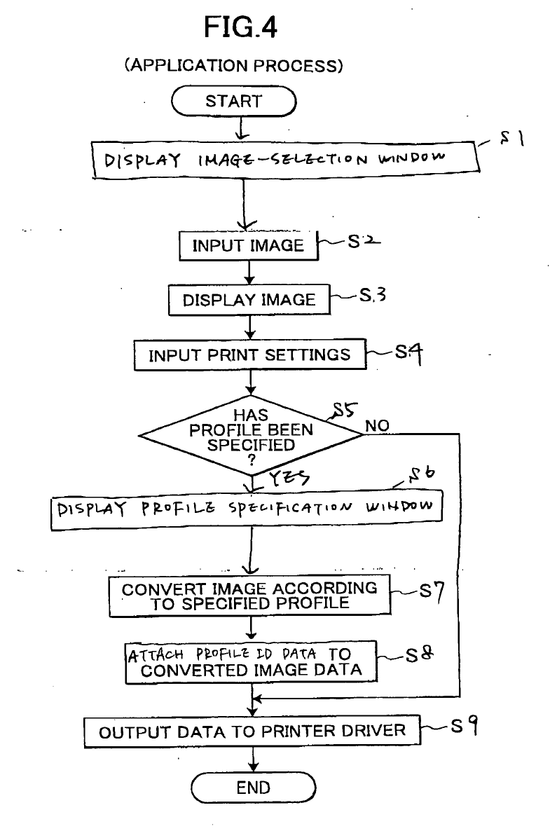

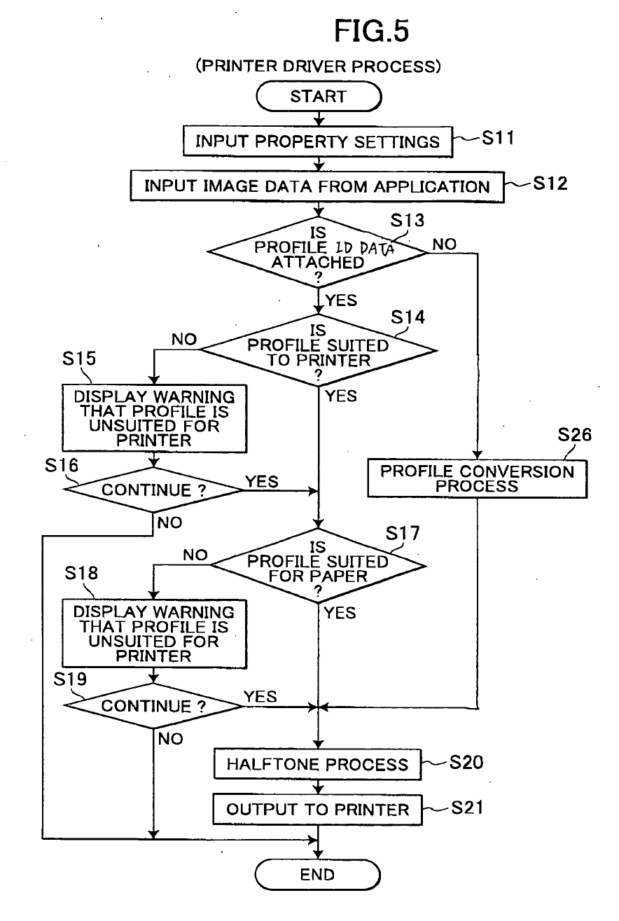

Next, a process performed with the application program will be described with reference to FIG. 4. FIG. 4 is a flowchart representing the process performed with the application program. When the application program is first started, in S1, an image-selection window (not shown) is displayed on the LCD 16 for enabling the user to select an image to be printed. The user selects an image by operating the mouse or the like. After an image to be printed was selected in S1, in S2 the CPU 11 transfers image data for the selected image from among image data stored in the image data memory 14d of the HDD 14 to the RAM 13, and in S3 displays the image on the LCD 16.

A window displayed on the LCD 16 at this time may also include a tool bar that enables the user to perform various settings, tools for editing the image or the like. By performing settings with these tools, the user can enlarge or reduce the image, modify brightness and contrast, and change hue and saturation. Thereafter, if the user wishes to print the image on a prescribed type of paper, the user inputs printing-related settings in S4. The printer-related settings include setting the paper size (A4, B5, etc.), setting the paper type (normal, glossy, etc.), and the like.

In S5, the user indicates if he/she wishes to specify a profile. If the user indicates in S5 that he/she wishes to specify a profile (S5: YES), then in S6, the profile specification window 25 shown in FIG. 2 is displayed, enabling the user to specify a profile. Next in S7, the CPU 11 performs color conversion on the image data based on the specified profile (profile conversion), in S8 attaches a profile ID data of the specified profile to the converted image data, and in S9 outputs the converted image data appended with the profile ID data to the printer driver. Then, the process ends.

On the other hand, if the user indicates in S5 that he/she does not wish to specify a profile (S5: NO), then the CPU 11 outputs the image data to the printer driver in S9 without performing profile conversion. Then, the process ends.

As described above, if a profile is specified when printing image data, the application program performs profile conversion based on the specified profile, attaches the profile ID data of the specified profile to the converted image data, and outputs the data to the printer driver. If a profile is not specified, the unconverted image data is outputted directly to the printer driver.

Next, the process performed with the printer driver will be described with reference to FIG. 5. FIG. 5 is a flowchart representing the process performed with the printer driver. In S11, the user sets properties of the printer in the printer driver prior to image data being inputted from the application program. The settings are performed in the Properties window 28 shown in FIG. 3. As described above, a profile best suited for the paper type selected in the Properties window 28 is selected at this time. In S12, image data is inputted from the application program. In S13, it is determined whether or not a profile ID data has been attached to the inputted image data. If so (S13: YES), this means that a profile has been specified in the application program and that profile conversion has been performed in the application program. Then, in S14 the printer driver determines whether the profile specified in the application program (the profile conversion that has been performed in the application program) is suited to the printer that performs the printing operation, based on the profile ID data. If not (S14: NO), then in S15 the printer driver displays a warning indicating that the profile specified by the application program is not suitable for the printer and prompts the user to select whether to continue or cancel the printing operation. If the user decides not to continue and selects “cancel” (S16: NO), the process is canceled.

However, if a positive determination is made in S14 (S14: YES), or if the user has indicated in S16 a desire to continue the printing operation (S16: YES), then in S17, the printer driver determines whether or not the selected profile is suited to the type of paper set in the printer driver. If not (S17: NO), then in S18, the printer driver displays a warning indicating that the profile specified in the application program is not suited to the type of paper and prompts the user to select whether to continue or cancel the printing operation. If the user decides not to continue and selects “cancel” (S19: NO), then the process is canceled.

However, if a positive determination is made in S17 (S17; YES), or if the user decides in S20 to continue the printing operation anyway (S19: YES), then in S20, the printer driver performs a halftone process on the image data and in S20 outputs the processed image data to the printer.

However, if a profile ID data has not been attached to the inputted image data (S13: NO), then in S26 the printer driver performs profile conversion based on the profile that was selected in S11. Then, the process advances to S20. It should be noted that in this illustrative aspect, the profile conversion process includes the calibration process but not the halftone process.

As described above, the printer driver according to this illustrative aspect does not perform profile conversion when a profile ID data has been attached to image data inputted from the application program, assuming that profile conversion has already been performed in the application program. Therefore, it is possible to prevent a profile conversion from being performed a plurality of times (twice), thereby suppressing a decline in image quality caused by profile conversion being performed a plurality of times (twice).

Further, the printer driver displays a warning when profile conversion performed in the application program is not suited for the printer or the recording paper.

While the invention has been described in detail with reference to the above aspects thereof, it would be apparent to those skilled in the art that various changes and modifications may be made therein without departing from the spirit of the invention.

For example, while the profile conversion process according the above illustrative aspect includes a calibration process, the calibration process need not be included in the profile conversion process. In this case, it is possible to perform the calibration process after performing the profile conversion as necessary.

Further, while the profile conversion process according to the above illustrative aspect does not include a halftone process, it is possible to include the halftone process in the profile conversion process. In this case, the halftone process need not be performed when the profile conversion was performed.

What is claimed is:

1. A storage medium storing an image-processing program for converting an image data into an image data that is suited to a prescribed printing device, the image-processing program comprising:
a) selectively performing a profile conversion on an image data in an application program;
b) determining whether the profile conversion has been performed on the image data in the application program; and
c) performing the profile conversion on the image data in a printer driver only when it was determined in the step b) that the profile conversion has not been performed on the image data.

2. The image-processing program according to claim 1, further comprising d) attaching a profile-conversion information to the image data when the profile conversion was performed on the image data in the step a), wherein the determination in the step b) is made based on whether the profile-conversion information is attached to the image data.

3. The image-processing program according to claim 1, further comprising e) outputting the image data to the prescribed printer without performing the profile conversion on the image data in the step c) when it was determined in the step b) that the profile conversion has been performed on the image data.

4. The image-processing program according to claim 1, further comprising f) determining whether the profile conversion performed in the step a) is suitable for the prescribed printer, and g) displaying a warning when it is determined in the step f) that the profile conversion performed in the step a) is unsuitable for the prescribed printer.

5. The image-processing program according to claim 4, further comprising h) attaching a profile-conversion information to the image data when the profile conversion was performed on the image data in step a), wherein the determination in the step g) is made based on the profile-conversion information attached to the image data.

6. The image-processing program according to claim 1, further comprising l) setting a type of recording medium on which the prescribed printer is to print, j) determining whether the profile conversion performed in the step a) is suitable for the type of recording medium set in the step i), and k) displaying a warning when it is determined in j) that the profile conversion is unsuitable for the type of recording medium.

7. The image-processing program according to claim 6, further comprising i) attaching a profile-conversion information to the image data when the profile conversion was performed on the image data in the step a), wherein the determination in the step j) is made based on the profile-conversion information attached to the image data.

8. The image-processing program according to claim 1, further comprising m) allowing an operator to specify a profile, wherein the profile conversion is only performed in the step a) based on the profile specified by the operator in the step m) when the operator has specified the profile in the step m).

9. An image-processing method for converting an image data into an image data that is suited to a prescribed printing device, the image-processing method comprising:
a) selectively performing a profile conversion on an image data in an application program;
b) determining whether the profile conversion has been performed on the image data in the application program; and
c) performing the profile conversion on the image data in a printer driver only when it was determined in the step b) that the profile conversion has not been performed on the image data.
